(19) United States
(12) Patent Application Publication
(10) Pub. No.: US 2009/0197534 A1
(43) Pub. Date: Aug. 6, 2009

(54) AUTOMATIC SETUP OF RADIO TRANSMISSION

(75) Inventor: Par STENBERG, Veberod (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/026,668

(22) Filed: Feb. 6, 2008

(51) Int. Cl. H04B 7/26

(52) U.S. Cl. 455/41.3

(57) ABSTRACT

The present invention relates to a method for setting up a radio transmission between a first and a second mobile communication device comprising the steps of, enabling the first device for radio transmission and sound reception, enabling the second device for sound transmission and reception of a radio transmission, initiating a radio transmission in the first device, where the radio transmission uses a radio broadcast technology to transmit a setup sound on a start frequency, receiving in the second devices, using the same radio broadcast technology, the radio transmission from the first device containing the setup sound, initiating a sound transmission of the received setup sound, in the second device, using a loudspeaker, and receiving, in the first device, by increasing/decreasing the start frequency, using a microphone the transmitted setup sound from the second device.

### TECHNICAL FIELD

The present invention relates in general to a method for automatic setup of a radio transmission between a plurality of electronic devices, such as a mobile communication devices. In particular the invention relates to automatic setup of an AM/FM-transmission between a mobile phone and a radio receiver such as the radio in a car stereo or in another mobile phone.

### BACKGROUND

Modern-day handheld communication devices, such as mobile phones, are no longer only used for speech and text communication. Nowadays the handheld device incorporates a wide variety of features that make it possible for the user to brows the Internet, play music, listen to radio, take pictures, navigate via GPS, and so on. The handheld communication device has thus been transformed from a portable speech and text communication device to a capable information, communication and entertainment center.

Listen to music on their handheld communication device, when travelling, is for many persons a way to relax and get into a mood. Most times a user uses headphones or earpieces to listen to music, or the radio, on the handheld device. However, in certain environments, such as in the car, it is not wise to use headphones since they will mask the surrounding sounds. Using the loudspeaker in the phone to play the music is in this situation not an option since it will not, or barely, be able to overcome the surrounding sound resulting in poor sound quality. One solution is to use an internal radio transmitter in the handheld device to transmit the music, via a FM/AM-radio transmission, to the radio receiver in the car stereo. In this way the music played in the users device will be transmitted to the radio and played through the loudspeakers connected to the car stereo, which has much better sound quality and output capabilities that the loudspeaker in the mobile phone.

Setting up a radio transmission between the handheld device and the radio receiver in the car stereo often involves several key presses on the handheld device and maneuvering of the radio buttons on the car stereo, before a satisfactory connection can be obtained. Doing the setup is quite tedious and it can also be dangerous if performed while driving a car.

### SUMMARY OF THE INVENTION

With the above description in mind, then, an aspect of some embodiments of the present invention is to provide an automatic setup procedure of a radio transmission between a transmitting portable communication device and a receiving portable communication device, which seeks to mitigate, alleviate or eliminate one or more of the above-identified deficiencies in the art and disadvantages singly or in any combination.

An aspect of the present invention relates to a method for setting up a radio transmission between a first and a second portable communication device comprising the steps of, enabling said first portable communication device for radio transmission and sound reception, enabling said second portable communication device for sound transmission and reception of a radio transmission, initiating a radio transmission in said first portable communication device, wherein said radio transmission use a radio broadcast technology to transmit a setup sound on a start frequency to said second portable communication device, receiving, in said second portable communication devices using said radio broadcast technology, said radio transmission on a second frequency from said first portable communication device, initiating a sound transmission in said second portable communication device, wherein said sound transmission uses a loudspeaker to transmit the sound in said received radio transmission on said second frequency to said first portable communication device, receiving, in said first portable communication device, said sound transmission using a microphone, and comparing said received sound with said transmitted setup sound in said first portable communication device, if said comparison is not a match, said start frequency is increased and/or decreased in said first portable communication device until said match is achieved.

The method may also comprise increasing and/or decreasing said start frequency in said first portable communication device until it matches said second frequency in said second portable communication device.

The method may also comprise the usage of a user-defined or preset radio broadcast technology and/or a user-defined or preset second frequency in said second portable communication device.

The method may also comprise maximising the reception strength, in said first communication device, of said received setup sound, by increasing and/or decreasing said start frequency in said first communication device.

The method may also comprise a radio broadcast technology being one of the following; amplitude modulated radio broadcast, frequency modulated broadcast, or digital audio broadcast.

The method may also comprise transmitting user selectable audio files together with Radio Data System data from the first to the second portable communication device.

Another aspect of the present invention relates to a transmitter/receiver device of a portable communication device type comprising, a microphone and a loudspeaker, means for initiating a radio transmission and/or a sound transmission reception, means for receiving a radio transmission and/or a sound transmission, means for selecting and using a start frequency, a second frequency, and a broadcasting technology, means for increasing and/or decreasing said start frequency, and means for comparing said received sound with said transmitted setup sound.

The transmitter/receiver device may also comprise means for increased and/or decreased said start frequency in said first portable communication device until it matches said second frequency in the second portable communication device.

The transmitter/receiver device may also comprise means for setting a user-defined or preset radio broadcast technology and/or means for setting a user-defined or preset second frequency in said second portable communication device.

The transmitter/receiver device may also comprise means for maximizing the reception strength of said received sound transmission.

The transmitter/receiver device may also comprise means for changing the start frequency, second frequency and/or the radio broadcast technology.

The transmitter/receiver device may also comprise means for using one of the following radio broadcast technologies; amplitude modulated radio broadcast, frequency modulated broadcast, or digital audio broadcast.

The transmitter/receiver device may also comprise means for transmitting user selectable audio files together with Radio Data System data from one transmitter/receiver device to another transmitter/receiver device.

Another aspect of the present invention relates to a radio transmission setup system, comprising at least two transmitter/receiver devices, for setting up a radio transmission between portable communication devices, said transmitter/receiver device each comprise, a microphone and a loudspeaker, means for initiating a radio transmission and/or a sound transmission reception, means for receiving a radio transmission and/or a sound transmission, means for selecting and using a start frequency, a second frequency, and a broadcasting technology, means for increasing and/or decreasing said start frequency, and means for comparing said received sound with said transmitted setup sound.

The features of the above-mentioned embodiments can be combined in any combinations.

### BRIEF DESCRIPTION OF THE DRAWINGS

Further objects, features and advantages of the present invention will appear from the following detailed description of the invention, wherein embodiments of the invention will be described in more detail with reference to the accompanying drawings, in which:

FIG. 1 shows a mobile communication device, in this case a mobile phone, according to an embodiment of the present invention; and

FIG. 2 shows a flowchart describing the steps included in the automatic setup procedure of the radio transmission, according to an embodiment of the present invention; and

FIG. 3a shows a setup procedure between a mobile phone and a radio receiver, according to an embodiment of the present invention; and

FIG. 3b shows a setup procedure between two mobile phones, according to an embodiment of the present invention; and

FIG. 4 shows a setup procedure between several mobile phones, according to an embodiment of the present invention; and

FIG. 5 shows the display of a mobile phone connected as a receiver, according to an embodiment of the present invention.

### DETAILED DESCRIPTION

Embodiments of the present invention relate, in general, to the field of electronic communication and radio broadcasting. A preferred embodiment relates to a portable communication device, such as a mobile phone, including one or more input devices. However, it should be appreciated that the invention is as such equally applicable to electronic devices which do not include any radio communication capabilities. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

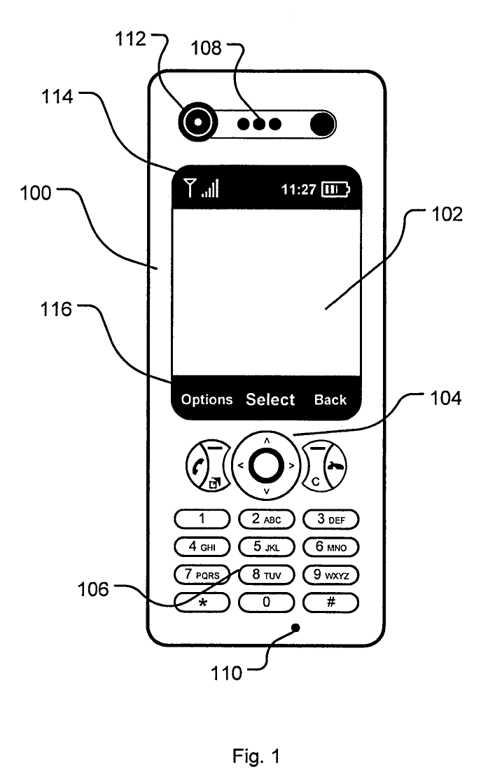

FIG. 1 show a mobile communication device 100 comprising a casing 101, a display area 102 and means 104 for navigating among items (not shown) displayed in the display area. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile communication apparatus 100 can also comprise other elements normally present in such a device, such as a keypad 106, a speaker 108, a microphone 110, a camera 112, a processor (not shown), a memory (not shown), an accelerometer (not shown), a vibration device (not shown), an AM/FM radio transmitter and receiver (not shown), a digital audio broadcast transmitter and receiver (not shown), etc.

To avoid the tedious and sometimes even dangerous setup procedures to connect the mobile phone to a radio as described in the background art, the following automatic setup procedure may be used.

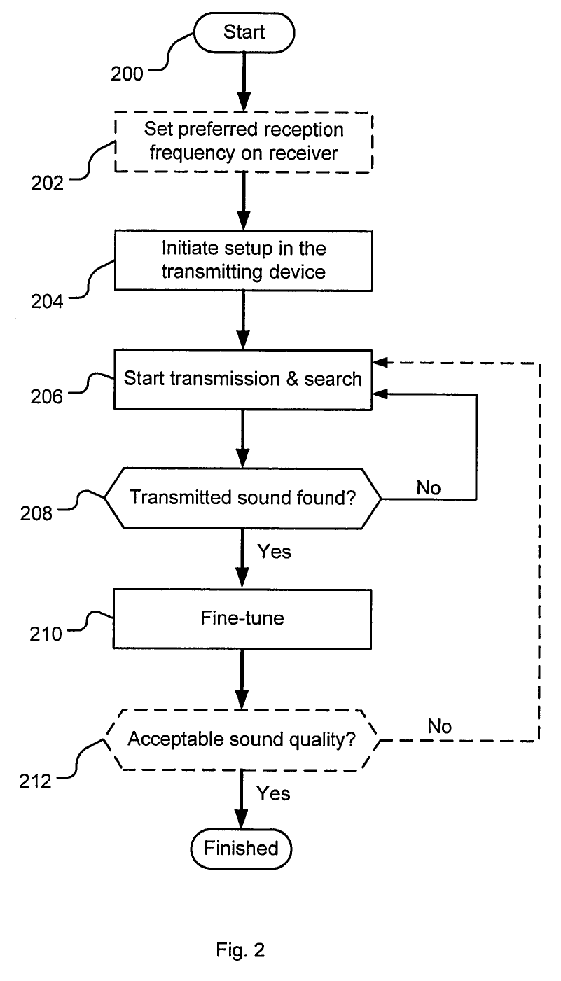

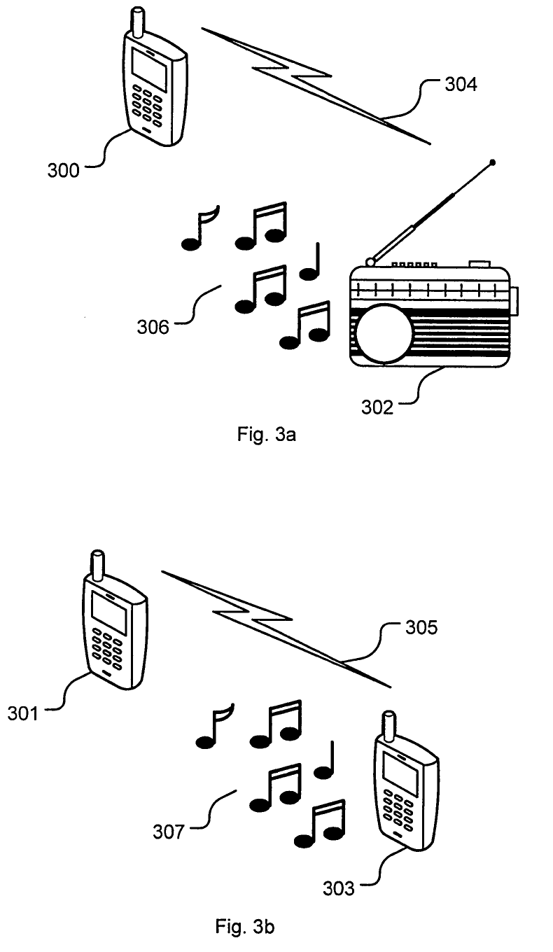

FIG. 2 shows a flowchart describing an automated setup procedure between two devices, one transmitting device and one receiving device, according to an embodiment of the present invention. To get a better understanding of the automated setup procedure, it will be exemplified using a mobile phone 300 as the transmitting device and a radio 302, such as an ordinary table radio for receiving FM broadcasts, as the receiving device. The scenario containing the two devices, the mobile phone and the radio, is depicted in FIG. 3a.

The automated setup procedure starts 200 by making sure that both devices, in this case the mobile phone 300 and the radio 302, are turned on and ready to be use. In an optional step (hence the jagged lines) 202 a preferred, a factory-predefined, or a user-defined reception frequency is set on the radio 302 (receiver). This step may be omitted since any frequency on the radio can be used, even an already occupied frequency used by a local, national or international broadcasting station. Most mobile phone FM transmitters, put close to a receiver, may locally produce a stronger radio signal than any broadcasting radio station. However, if a situation should arise where this is not the case, then step 202 can be included to ensure that an unused radio frequency on the radio is use. If stage 202 has to be used, the user will be prompted by a visual or an audio alert to set a suitable reception frequency on the radio. The visual or audio alert may be in the form of a message displayed on the screen, blinking of on the display, showing a specific icon, beeping a special sound, playing a pre-recorded message, or some other way of getting the users attention. In the next step 204 the user initiate the automated setup procedure by for instance presses a key, a softkey, or by giving a voice command to the mobile phone 300. The initiation process 204 may include several operations such as launching a setup application, initiating the transmitter unit in the mobile phone, enable the mobile phone's microphone for reception (listening), choosing a start transmission frequency, and other necessary operations. Choosing a start frequency can be done in several ways depending on which broadcasting technology is used. In an embodiment the used broadcasting technology may be a frequency modulated radio transmission (FM-radio), which throughout the world uses the broadcast band of 87.5 to 108.0 MHz (i.e. in the VHF range), or some portion thereof. The only exceptions are Japan which uses the 76 to 90 MHz band, and some Eastern Bloc nations where an older band ranging from 65.9 to 74 MHz also may be used. In an embodiment the starting frequency may for instance be pre-set to 89 MHz, which are in use in most countries, or to any of the low/high frequencies 108 and 65.9 MHz. In another embodiment the used broadcasting technology may be an amplitude modulated radio transmission (AM-radio), which mainly uses three frequency bands namely, short wave (2.3 MHz-26.1 MHz), medium wave (520 kHz-1,610 kHz), and long wave (153 kHz-279 kHz). In an embodiment the starting frequency may for instance be pre-set to any frequency within any of the three frequency bands used by AM-radio. However, if the user(s) is located in Europe, Africa, Oceania and parts of Asia a frequency within the long wave band is preferably chosen, and if the user(s) are located in America a frequency within the medium wave band is preferably chosen. If some other broadcasting technology is used, another start frequency may be appropriate to choose. Independent of broadcasting technology, the start frequency may be user-set to a preferred frequency, or automatically set to a preferred frequency depending on location due to the fact that in some locations transmission on certain frequencies may be prohibited or unsuitable. The mobile phone could also scan, with its radio receiver, the radio frequencies to determine a suitable frequency to transmit on. Also a previous used frequency, stored in the mobile phones memory, can be used as a starting frequency.

In the next step 206 the mobile phone 300, being the transmitting device, starts to transmit on the chosen start frequency, and at the same time starts to “listen” after the transmitted sound via its microphone 208. Several different sounds can be chosen to be used in the setup procedure. In one embodiment an audio signal, such a music note of a predefined frequency, can be chosen. In another embodiment the music track that the user wants to listen to may be transmitted and the mobile phone will compare the sound received by the microphone with the music track playing in the transmitter, with any transmission delay of the sound taken into account. In yet another embodiment a sound outside a human's normal hearing range (roughly 20 Hz to 20 kHz) can be used to setup the transmission as long as the microphone is capable of detecting it.

If the transmitted frequency (start frequency) is the same as the frequency which the radio is tuned to (second frequency), the radio 302 will pick up the transmitted sound 304 and begin to play it through its speaker system 306 (i.e. start frequency=second frequency). In step 208 the mobile phone 300 will listen for the transmitted sound to begin to play through the radio's speaker system, i.e comparing received sound from radio with the transmitted sound in the mobile, to determine if the transmission frequency of the mobile phone 300 is the same as the reception frequency on the radio 302. If the transmitted sound is the same as the sound coming from the radio, i.e matches each other, the correct transmission frequency is found. If the picked up sound(s) are not the same as the transmitted sound (start frequency≠second frequency), a correction of the transmission frequency must be done by returning to step 206 and make a small change to the transmission frequency. The change of the transmission frequency in the mobile phone 300 can be done in several ways. Depending on the start frequency chosen in step 204 the frequency may either be increased or decreased by a certain amount, for instance 0.2 MHz if an FM broadcasting technology is used.

If all frequencies, ranging from the chosen start frequency to an end frequency for the currently used broadcast technology, have been transmitted on without detecting the transmitted sound, stage 206 chooses a new start frequency and/or a new broadcasting technology. For example, a FM broadcasting technology with a start frequency of 100 MHz is initially chosen. When the transmitted sound was not detected 208 on that frequency the transmission frequency was increased in steps of 0.2 MHz until the transmission frequency reached the end frequency 108.0 MHz of the FM frequency band. Since the whole FM frequency band hasn't been transmitted on, a new start frequency 108.0 MHz was chosen in step 206. When the transmitted sound was not detected at that frequency, the transmission frequency was decreased with 0.2 MHz until the transmitted sound was found on, in this example, 95.0 MHz. If the correct reception frequency had not been found, a new broadcast strategy, for example AM, and a new start frequency had to have been chosen in stage 206. When all frequencies in all broadcast technologies have been transmitted on without detecting the transmission sound, the user may be prompted to either continue searching, i.e. restarting the search, or to exit the search and manually tune the transmission. If the radio receiver is at a distance and/or the surrounding environment is very noisy it is possible that the transmitted sound coming from the receiver is not registered properly by the microphone on the transmitter. To minimise the risk of not picking up the sound from the receiver the two devices which are involved in the automatic setup procedure should be placed in close proximity during the setup procedure.

When the transmitted sound 306 is detected by the mobile phone 300 fine tuning 210 of the transmission frequency may have to be performed. This is due to the fact that many times the transmission frequency, when the first sound coming from the radio is detected, often does not correspond to the optimal transmission frequency with the best sound quality. Therefore, fine tuning 210 of the transmission frequency to obtain the best output sound quality from the radio is in order. In the fine tuning stage 210 the frequency is slowly changed in small increments, for example 0.05 MHz if FM broadcasting technology is used, either up or down in frequency depending on start frequency while the output sound 306 from the radio 302 is monitored by the mobile phone 300. If the sound quality is improving the fine tuning process continues. If the sound quality is getting worse (i.e. low reception strength) the tuning stops and reverses the frequency change, thus changing towards the frequencies that produced a better sound output quality from the radio 302. An optional step 212 may be included in the automated setup procedure which determined if the sound quality from the fine tune step 210 is acceptable or not. In some cases the arrived to transmission frequency may not produce a god sound quality (i.e. high reception strength) due to some interference. In step 212 a predetermined (factory preset or user-set) level of sound quality is compared with the sound detected by the mobile phone's 300 microphone. If the received sound quality is lower than the determined quality level, a new start frequency is chosen by returning to step 206. When the frequency producing the best sound quality (i.e. high reception strength) is found the automatic setup procedure is completed.

By applying the automatic setup described above the user of a mobile phone 300 may easily connect to and play music via a radio 302 without having to go through the tedious process of entering transmission frequencies and fine tune the settings by hand.

FIG. 3b shows another example of an embodiment of the present invention. In this example both the transmitting and the receiving device is a mobile phone 301, 303. By using the automatic setup procedure, described by the flowchart in FIG. 2, a user with a mobile phone 301 may easily setup a transmission between a first mobile phone 301 and a second mobile phone 303. In this way a user may share a song with another user without any downloading. For example, a first user wants to share a track with his friend he initiates an automatic setup procedure with himself as the transmitting part and his friend as the receiving part. In this way both persons are going to be able to listen to the same track without the hassle exchanging tracks via Bluetooth or some other connection technology.

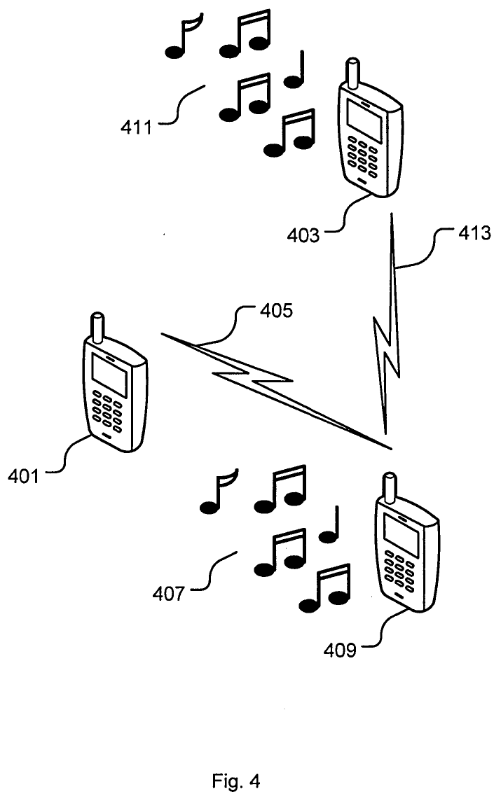

FIG. 4 shows an extension of the embodiment discussed in conjunction with FIG. 3b. In this example three persons having mobile phones 401, 403, 409 may want to hear the same track which is only present in one of the mobile phones 401. Mobile phone 401 initiates an automatic setup procedure with mobile phone 409, according to the flowchart in FIG. 2. When the connection is finished the track playing in mobile phone 401 may be listen to in mobile phone 409. Then mobile phone 409 initiates an automatic setup procedure with mobile phone 403, transmitting the sound track received from mobile 401. In this way the music is transmitted from mobile phone 401 to mobile phone 409 via a specific frequency and broadcast technology. The music is then transmitted 413 from mobile phone 409 to mobile phone 403 on another frequency, with the same or with a different broadcast technology, so that the transmission 405 between mobile phone 401 and 409 is not disturbed. In this way a broadcasting chain is formed by the pairing of mobile phones via the automatic setup procedure disclosed by the invention.

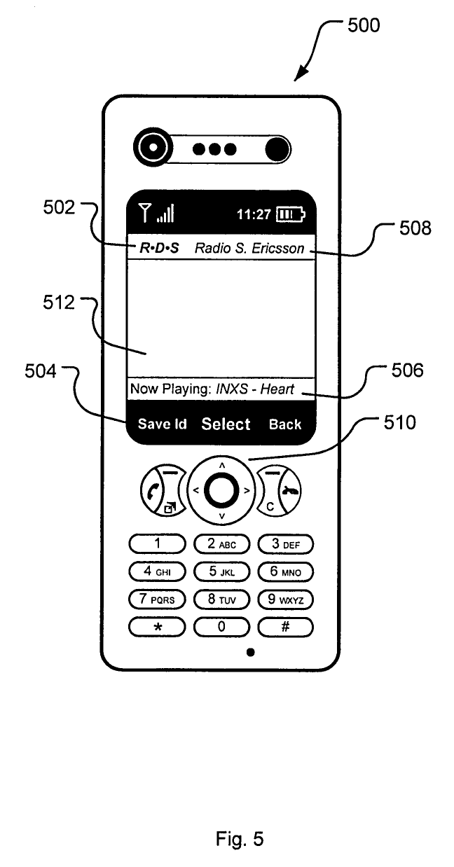

In all of the above embodiments the Radio Data System (RDS), which is a standard from the European Broadcasting Union for sending small amounts of digital information using conventional FM radio broadcasts, may for instance be utilized to send current track information from a transmitting mobile phone to a mobile phone connected as a receiver. FIG. 5 shows how it can look in a mobile phone, connected as a receiver, when receiving a transmission from another mobile phone according to the automatic setup discussed in FIG. 2. In a top menu 502 the RDS logo is shown together with information about who is transmitting, in this case a user of a mobile phone which calls himself Radio S. Ericsson 508. In a bottom menu 506 the current track played, track id, is shown, which in this case is a song with the name ‘Heart’ performed by the group INXS. The current track id can be saved 504 to the mobile phone, and may be used to lookup and buy the track on an Internet music store.

In another embodiment of the present invention Digital Audio Broadcasting (DAB), also known as Eureka 147, which is a digital technology for broadcasting radio stations, may be used as broadcasting technology.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for setting up a radio transmission between a first and a second portable communication device comprising the steps of:
enabling said first portable communication device for radio transmission and sound reception;
enabling said second portable communication device for sound transmission and reception of a radio transmission;
initiating a radio transmission in said first portable communication device, wherein said radio transmission use a radio broadcast technology to transmit a setup sound on a start frequency to said second portable communication device;
receiving, in said second portable communication devices using said radio broadcast technology, said radio transmission on a second frequency from said first portable communication device;
initiating a sound transmission in said second portable communication device, wherein said sound transmission uses a loudspeaker to transmit the sound in said received radio transmission on said second frequency to said first portable communication device;
receiving, in said first portable communication device, said sound transmission using a microphone; and
comparing said received sound with said transmitted setup sound in said first portable communication device, if said comparison is not a match, said start frequency is increased and/or decreased in said first portable communication device until said match is achieved.

2. The method according to claim 1, wherein said start frequency is increased and/or decreased in said first portable communication device until it matches said second frequency in said second portable communication device.

3. The method according to claim 1, further comprises using a user-defined or preset radio broadcast technology and/or a user-defined or preset second frequency in said second portable communication device.

4. The method according to claim 1, further comprises maximising the reception strength, in said first communication device, of said received setup sound, by increasing and/or decreasing said start frequency in said first communication device.

5. The method according to claim 1, wherein said radio broadcast technology may be one of the following; amplitude modulated radio broadcast, frequency modulated broadcast, or digital audio broadcast.

6. The method according to claim 1, further comprises transmitting user selectable audio files together with Radio Data System data from the first to the second portable communication device.

7. A transmitter/receiver device of a portable communication device type comprising;
a microphone and a loudspeaker;
means for initiating a radio transmission and/or a sound transmission reception;
means for receiving a radio transmission and/or a sound transmission;
means for selecting and using a start frequency, a second frequency, and a broadcasting technology;
means for increasing and/or decreasing said start frequency; and
means for comparing said received sound with said transmitted setup sound.

8. The transmitter/receiver device according to claim 7, further comprises means for increased and/or decreased said start frequency in said first portable communication device until it matches said second frequency in the second portable communication device.

9. The transmitter/receiver device according to claim 7, further comprises means for setting a user-defined or preset radio broadcast technology and/or means for setting a user-defined or preset second frequency in said second portable communication device.

10. The transmitter/receiver device according to claim 7, further comprises means for maximizing the reception strength of said received sound transmission.

11. The transmitter/receiver device according to claim 7, further comprises means for changing the start frequency, second frequency and/or the radio broadcast technology.

12. The transmitter/receiver device according to claim 7, further comprises means for using one of the following radio broadcast technologies; amplitude modulated radio broadcast, frequency modulated broadcast, or digital audio broadcast.

13. The transmitter/receiver device according to claim 7, further comprises means for transmitting user selectable audio files together with Radio Data System data from one transmitter/receiver device to another transmitter/receiver device.

14. A radio transmission setup system, comprising at least two transmitter/receiver devices, for setting up a radio transmission between portable communication devices, said transmitter/receiver device each comprise:
a microphone and a loudspeaker;
means for initiating a radio transmission and/or a sound transmission reception;
means for receiving a radio transmission and/or a sound transmission;
means for selecting and using a start frequency, a second frequency, and a broadcasting technology;
means for increasing and/or decreasing said start frequency; and
means for comparing said received sound with said transmitted setup sound.
